(19) United States
(12) Patent Application Publication
(10) Pub. No.: US 2021/0107368 A1
(43) Pub. Date: Apr. 15, 2021

(54) CHARGING STATION FOR ELECTRIC VEHICLES

(71) Applicants: Stefan Helnerus, Arnsberg (DE); Christian Müller-Winterberg, Dorsten (DE)

(72) Inventors: Stefan Helnerus, Arnsberg (DE); Christian Müller-Winterberg, Dorsten (DE)

(73) Assignee: Innogy SE, Essen (DE)

(21) Appl. No.: 17/106,371

(22) Filed: Nov. 30, 2020

Related U.S. Application Data
(63) Continuation of application No. PCT/EP2019/055739, filed on Mar. 7, 2019.

(30) Foreign Application Priority Data
May 30, 2018 (DE) 10 2018 112 954.8

(51) Int. Cl. B60L 53/30; B60L 53/66; B60L 53/10

(52) U.S. Cl. CPC B60L 53/305; B60L 2250/16; B60L 53/11; B60L 53/665

(57) ABSTRACT

A charging station for electric vehicles having a tray assembly and a lid assembly. The tray assembly has at least one power module, a first charging control circuit, and at least one charging outlet. The lid assembly is adapted to receive at least one communication module and at least one user interface module.

### CROSS-REFERENCE TO RELATED PATENT APPLICATIONS

This patent application is a continuation of International Application No. PCT/EP2019/055739, filed on Mar. 7, 2019, which claims the benefit of priority to German Patent Application No. 10 2018 112 954.8, filed May 30, 2018, the entire teachings and disclosures of both applications are incorporated herein by reference thereto.

### FIELD

The subject matter concerns a charging station for electric vehicles, a docking station for charging stations and a charging station in a charging station as well as modules installed in a charging station.

### BACKGROUND

The installation of the charging infrastructure is of crucial importance for the nationwide establishment of electromobility. To this end, it is necessary to install charging stations for electric vehicles on a large scale in public and semi-public areas. The charging stations should be integrated into the street scene and are therefore usually designed as charging columns. Charging columns are characterized by a compact design with a small footprint. The charging stations are usually stele-like and have integrated or connectable charging electronics.

As mentioned above, the extensive expansion of the charging infrastructure is an essential factor for the acceptance of electromobility. Therefore, charging columns have to be installed in as wide an area as possible and in large numbers within a short time. This is a challenge with regard to the design, construction and actual installation on site of the charging columns, because due to the mass use of the charging columns, it must be possible to produce them on an industrial scale and they should be particularly easy to install on site, preferably by a single person.

This is only partially the case with previous charging stations. On the one hand, on-site installation is complex and costly, on the other hand, the electronics in the charging stations cannot be produced cost-effectively and in large quantities.

For a particularly simple installation of charging technology, it is also necessary that it can be installed in a few manual steps and even by untrained persons. The connection to the power supply should where possible be decoupled from the rest of the charging technology to ensure that even laymen can install charging technology. Also the possible maintenance as well as the exchange of charging technology, which for example becomes necessary due to defects or technology changes, should be simplified as much as possible.

### BRIEF SUMMARY

Based on the above mentioned problem, a charging station for electric vehicles is proposed.

The charging station can be placed as a supply level on a docking station that is arranged as a connection level. For this purpose, the charging station comprises a tray assembly and a lid assembly. The tray assembly together with the lid assembly forms a housing in which the charging technology for the charging station is accommodated. The connection of the charging technology to a power supply is carried out in the manner of a modular system by mounting the charging station on a docking station. This assembly is preferably done without tools.

At least one power module is arranged in the tray assembly. The power module, in the following also called HPS module (High Power Safety Module), comprises components which are necessary for power control and power monitoring.

In addition, a first charging control circuit and a charging outlet can be arranged within the tray assembly. The components arranged in the tray assembly can be sufficient to provide basic functionalities for charging an electric vehicle. The tray assembly includes a base which, when assembled, faces a protective housing cover of the docking station. The side of the tray assembly opposite of the bottom is preferably essentially closed by the lid assembly. The lid assembly is used to accommodate at least one communication module and at least one user interface module. With the help of the communication module, the charging functions of the power module can be extended and in particular extended protocol functionalities can be implemented. A user interface module enables an interaction with a user. The power module provides a power supply for a communication module as well as for a user interface module. The communication module can optionally be connected to a wide area network connection within the docking station. The communication module can also optionally be connected to a charging network within the docking station. The communication module can also establish communication in a near field.

The communication module, in the following also called ECU (Electronic Control Unit Module) can act as a control computer and communication gateway.

The user interface module, in the following also called UIB (User Interface Board), comprises input and/or display elements, for example at least one display, touch display, pictogram, capacitive/inductive touch sensor and/or an environmental sensor. These can be controlled and/or read out by the UIB. The UIB can be connected modularly to the ECU module, whereby a UIB in a basic function exclusively has status LEDs as a display element to indicate the operating status and in a more comprehensive configuration has and/or controls at least one of the additional operating and/or display elements mentioned above.

The charging station can be coupled to a docking station via a power connection without tools. To this end, a circuit board can be arranged as a main board within the docking station, which has the power connection. For a secure coupling without tools between the charging station and the docking station, either the circuit board of the main board can be floatingly mounted in the docking station in a plane parallel to the bottom of the docking station and/or parallel to the plane of the protective housing cover of the docking station or the HPS module can be floatingly mounted in a plane parallel to the bottom of the tray assembly.

Within the docking station there can be a functional separation between the power electronics and the communication electronics. For this purpose, a circuit board can be installed inside the docking station in addition to the main board as an interface board, on which external data connections are connected via corresponding connector sockets. The connector sockets can be connected via patch cables, which are inserted into the tray assembly and in there are connected especially to the ECU module.

Preferably, the interface board has a connector socket which has connections for a first general purpose input/output bus (GPIO) on the one hand and a CAN bus on the other hand. This makes cabling between the interface board and the ECU module particularly easy, since two different buses can be routed via a single cable.

The connection of a LAN between the interface board and the ECU is preferably done with a patch cable whereby connections of two separately operated LAN networks can also be routed on one cable and in the respective sockets. Thus, a connection of two different local networks is possible via a single cable.

The tray assembly is preferably a tray-shaped housing with side walls. The side walls enclose the power module circumferentially, preferably completely circumferential. The side walls thus provide a lateral seal for the tray assembly. An outlet for a charging cable can be provided in the side wall. A permanently attached charging cable can be connected via the charging connector if no charging socket is to be installed electrically. The outlet of the charging cable is preferably located in a recess of a side wall. The side wall can jump back into the interior of the tray assembly, especially in the area where a charging socket is located. If a permanently attached charging cable is used, an unwired charging socket can be located in the tray assembly to act as a “plug garage”.

The tray assembly preferably also comprises a bottom. In the assembled state, the bottom of the tray assembly is flush with the protective housing cover of the docking station. Preferably, the bottom is facing the protective housing cover of the docking station.

As already explained, the HPS module can be formed as a circuit board. In order to ensure that the HPS module can be coupled to the power connection particularly easily at the docking station, the HPS module is mounted floatingly. The floating support makes it possible to align the plug and socket of the power connection to each other during the assembly process by moving the floating circuit board in the plane of the support with the help of guiding means.

Like the docking station, the charging station also has a power connection. This is located on the HPS module. The power connector is preferably a connector corresponding to the power connector on the docking station. The power connections correspond to each other according to the socket-plug principle, whereby the power connection on the HPS module is preferably formed as a plug, whereas the power connection on the docking station is formed as a socket.

The power connection is located in a recess in the bottom of the tray assembly. In order to prevent that during the assembly of the charging station on the docking station, while also the power connectors are being plugged into each other, at least one contact of the power connector is exposed in such a way that it could be touched by a user, it is proposed that the power connector of the HPS module is enclosed by a circumferential shroud. The shroud preferably completely surrounds the power connector and extends through the bottom of the tray assembly facing away from the inside of the tray assembly. The shroud can be located on the bottom itself or on the circuit board of the HPS module. The shroud preferably has a length that is approximately the length of the longest contact of the power connector. Thereby, the power connector is only open at the bottom and is enclosed laterally by the shroud and covered at the top by the circuit board of the HPS module. This ensures sufficient touch protection for mounting the charging station on the docking station without tools.

Furthermore, the bottom of the tray assembly can have an opening provided in the area of the charging socket. The opening can be a recess to accommodate the charging socket. In particular, the opening allows the charging socket to be operated manually from the lower end, i.e. from the bottom, and in particular to be unlocked. In case of a failure, a charging plug inserted in the charging socket may be locked. Usually this lock is unlocked by a powered emergency release means. In case of a power failure, however, this release means may not function properly. Since it should be ensured where possible that the charging station is currentless during the emergency release, an emergency release from the ground is proposed. As the emergency release is then e.g. only possible from the bottom, it is necessary to remove the charging station from the docking station. Here, the electrical connection between the power connections of the docking station and of the charging station must be disconnected, so that the charging station is necessarily without power and the mechanical emergency release can be carried out without danger.

The charging station should be as modular as possible so that a wide variety of equipment variants can be operated as required. This also means that it should be possible to accommodate different charging sockets by the tray assembly. Therefore, a modular receptacle for the charging socket is proposed, which preferably can be operated without tools. For this purpose, a receptacle for a charging socket is provided in the tray assembly, whereby the receptacle has fixing means for detachably fixing the charging socket to the tray assembly. The charging socket can be arranged in the tray assembly with corresponding fixing means. For this purpose, the charging socket can be arranged on a receptacle body. The receptacle body has a larger base area than any possible charging socket. The charging socket is preferably arranged in the center of a surface of the receptacle body. The receptacle body is designed in such a way that it can accommodate various types of charging sockets. However, the fixing means of the receptacle body corresponding to the fixing means, which form the interface, are identical for all different charging sockets. This is achieved by the receptacle being dimensioned in such a way that the interface remains unchanged even if the charging sockets are changed. This achieves modularity, since the charging station can accommodate and operate a wide variety of different types of charging sockets. The receptacle bodies are designed to accommodate different types of charging sockets. Charging sockets can be of type 1, 2 or 3, CCS according to IEC 62196 or a Chademo. Other types of charging sockets can also be arranged in the receptacle body.

The fixation means in the tray assembly are preferably formed by comb-shaped flanges with aligned openings. Corresponding fixing means can be provided on the receptacle body of the charging socket or on the charging socket. The receptacle body of the charging socket may also be provided with comb-shaped flanges which interact with and engage with the flanges of the fixing means. Pins can be inserted through the openings of the flanges, which are aligned with each other, so that the receptacle body or the charging socket can be fixed positively lockingly to the fixing means and thus to the tray assembly.

To fix the charging station to the docking station, it is proposed that bottom-side webs are arranged on the tray assembly that extend away from the inside of the tray assembly. The webs may be designed to engage in recesses on the docking station. By pushing the webs into the recesses on the docking station, the webs can be positively locked to the docking station.

The HPS module can be equipped with at least one circuit breaker for performance monitoring. The power module may in particular have a sensor for monitoring the neutral conductor as well as the earth conductor and/or a residual current circuit breaker and/or a short circuit breaker and/or a welding detection sensor. All these sensors can have switching functionalities or can control a switch.

On the circuit board of the power module the first charging control circuit, a charging outlet and the circuit breaker can be arranged. The charging outlet is wired in such a way that the charging socket can be connected to the charging outlet via connecting clamps. In particular, the phases L1, L2, L3 as well as neutral conductor PE and ground conductor N can be contacted at the charging outlet. In addition, the charging outlet can have a CP and a PP connection, whereby these connections can be arranged in a connector that is separate from the power connections.

According to an embodiment, it is proposed that the first charging control circuit on the power module is arranged to communicate with an electric vehicle via a power conductor, in particular by means of pulse width modulation. In particular, the first charging control circuit enables communication according to DIN 61851. This charging control circuit comprises a basic functionality to first negotiate the readiness for charging with an electric vehicle.

As already explained, the charging outlet serves to connect either a charging socket or a charging cable permanently attached to the tray assembly. The charging outlet is located in the tray assembly and connected to a charging cable located on the tray assembly and routed out of the tray assembly or connected to a charging socket in the tray assembly. The charging outlet preferably comprises a connection strip with connections for the individual phases, a neutral conductor and a protective earth conductor on the one hand and an at least two-pole plug for accommodating PP and CP connections on the other hand.

As already explained, the tray assembly can be closed by the lid assembly with the exception of the charging socket. The lid assembly can accommodate the communication module and the user interface module. When mounting the user interface module or the communication module in the lid assembly, the user interface module can be arranged first from the lid surface and then subsequently the communication module. This means that the user interface module is sandwiched between the lid surface and the communication module.

The communication module and the user interface module are preferably each formed on their own circuit board. This increases the modularity of the charging station, since the communication module and the user interface module can each be assembled separately in the lid assembly. Thus, either a communication module or a user interface module or both modules can be arranged in the lid assembly as required. In addition, the temperature management is considerably optimized. If the power module is at the bottom of the tray assembly and the communication module and/or the user interface module is in the lid assembly, the modules are spaced apart so that the temperature management within the tray assembly can be optimized.

The lid assembly preferably corresponds completely to the tray assembly, in particular the footprints of the lid assembly and tray assembly are such that the lid assembly rests completely on the tray assembly when mounted. For fixing, in particular, latching elements are provided on the side walls of the lid assembly, which can latch on the inside of the side walls of the tray assembly. This allows the lid assembly to be connected to the tray assembly. The latching elements can be such that fixing occurs by an engaging behind. Furthermore, the latching elements can be such that they can only be released on the bottom side, i.e. only in the case of a tray assembly that has been mechanically released from the docking station. This increases safety, since the lid assembly always provides touch protection and the lid assembly cannot be lifted off the tray assembly as long as the tray assembly is resting on the docking station with its bottom side. Only when the tray assembly has been removed from the docking station and the charging station is therefore inevitably free of electrical voltage, the lid assembly can be removed from the tray assembly by releasing the latching elements.

According to an embodiment, it is proposed that the communication module and the user interface module are located in a first area of the lid surface and that a shutter is located in a second area on the lid surface corresponding to the charging socket in the tray assembly. The shutter has a movable element which can be moved on the inside of the lid assembly. The shutter can be spring-loaded so that it is always in a closed position when no force acts on it. The shutter can be manually pushed in parallel to the inner surface of the lid assembly, opening an opening that is directly above the charging socket. This allows a charging plug to be inserted into the charging socket. After removing the charging plug, the spring elements can ensure automatic closing of the shutter.

According to an embodiment, it is proposed that the user interface module is attached to the inside of the lid surface. In particular, the user interface module is fixed immovably to the lid surface of the lid assembly. On the circuit board of the user interface module signal transmitters and/or signal sensors may be provided on the side facing the lid surface. Controls or indicators may be located on the outside of the lid surface. The mechanical fixation of the user interface module to the lid assembly ensures that the user interface module's sensors and/or signal transmitters are aligned with controls or indicators located on the outside of the lid surface and that their relative positioning to each other is always correct.

The communication module and/or the user interface module are attached to the lid assembly. Attachment to the tray assembly is exclusively done indirectly by attaching the lid assembly to the tray assembly. Thus, the communication module and user interface module are mechanically connected to the power module only indirectly via the connection between the lid assembly and the tray assembly.

An electrical connection between the communication module and/or user interface module and the power module is made by at least one flexible cable.

The communication module has a second charging control circuit. This second charging control circuit serves to communicate with an electric vehicle via a pilot conductor. For this purpose, the second charging control circuit can at least access the pilot conductor of the charging outlet. In particular, the second charging control circuit acts according to DIN 15118. Other higher order protocols are also possible. The second charging control circuit is connected to the first charging control circuit in particular in such a way that the second charging control circuit can override the first charging control circuit. Also, a parallel operation is possible, so that both a communication over the first charging control circuit and the second charging control circuit can take place, whereby then the first charging control circuit is synchronized with the second charging control circuit.

According to an embodiment it is proposed that the communication module has an encryption module. The encryption module is especially formed as a TPM module. The encryption module can be used to encrypt measured values of the measuring device installed in the docking station. For this purpose, a connection between a measurement value output of the measuring device in the docking station and the encryption module can be established via a corresponding patch cable. The encryption module can encrypt the measured values measured and received by the measuring device (Smart Meter, iMS) and, if necessary, transmit them via a wide area network to a billing center.

The docking station has a tray-shaped housing with a bottom and surrounding side walls. Furthermore, the docking station has a cable entry leading into the housing. The cable entry can be located in the side walls or in the bottom. Since the docking station is arranged for installation either directly on a wall or in a receptacle which is arranged in a stele for instance, the cable entry is located either in the side walls or in the bottom.

Inside the housing of the docking station there is at least one connection strip for a power supply cable. On this connection strip the power supply cable, for example multi-phase, e.g. single-phase or three-phase, can be connected together with for example a neutral conductor and/or a protective earth conductor. The connection strip is preferably located at the bottom of the housing. In addition to the connection strip for a power supply cable, a contact strip or a connection socket for a network connection, for example according to the Cat 5, Cat 6 or Cat 7 standard or similar, can also be provided. The network connector allows a connection with a local network arranged externally of the docking station or with a wide area network, for example DSL, ADSL or similar. In order to be able to form a local network (charging network) with other charging stations from the docking station and at the same time be connected to a network that is external to the charging network, the network connection can be arranged to connect to two networks that can be operated independently of each other.

To simplify the installation of charging technology, according to the subject matter a systematic separation between a connection level for power technology and a supply level for charging technology is proposed. The docking station serves as a connection level for an energy supply network, in particular by using the connection strip and also has, within the housing, a receptacle for an energy meter, e.g. an intelligent measuring system (iMS) or a smart meter. The housing of the docking station separates this connection level for the energy supply network from the supply level for the charging technology by providing a power connection in the docking station for a charging station located outside the docking station. In particular, the power connection has a socket with several connecting contacts, whereby each of these can be connected to one phase of the power supply cable, the neutral conductor and, if necessary, a protective earth conductor.

In addition, a converter or rectifier can be provided within the docking station, which adds at least two additional connecting contacts of the power connection, and via which the charging station arranged outside the docking station can obtain additional electrical power if necessary.

The separation between the connection level and the supply level makes it possible to install charging technology even for the layman. According to the subject matter it is only necessary that the docking station or the connection of the docking station to the power supply cable is carried out by a qualified technician. After this connection has been made, the housing of the charging station can mostly be closed. A further installation of charging technology is not necessary for the time being.

The docking station as such does not have any “intelligence” in the sense of the ability to carry out charging control. Rather, at a later point in time a charging station that is separate from the docking station can be easily and conveniently connected to the docking station by a layman via the power connection. Since the power connection to the power supply network is located within the docking station, there is no danger of an electric shock for the person who couples the charging station to the docking station.

It is proposed that the docking station can be coupled with a charging station. This charging station serves as a supply level for a charging technology and is especially equipped with a charging control circuit. Depending on the application, there may be different requirements for the charging technology. A universally applicable docking station, which secures the high-voltage connection to the electrical supply network, offers the advantage that differently designed charging stations can be mechanically and electrically connected with such a docking station. As a result, at first only docking stations need to be installed and the charging technology can subsequently be coupled to the docking station.

If newer or modified charging technology becomes necessary, it is possible to simply uncouple the charging station from the docking station and couple a new charging station to the docking station via the power connection. If the charging station is also encapsulated in its own housing, the coupling of the charging station to the docking station can be done by a technical layman.

This has particular advantages in the installation process, as the provision of the charging station can be decoupled in time from the installation of the docking station. After a docking station has been installed by a technician, any layman can connect the charging technology suitable for them to the docking station by means of a suitably prepared charging station. This makes the installation process much easier for the supplier of charging technology. In a simple installation step, the docking station is connected to the power supply network. Afterwards the installation can be finished by a layman.

The connection level is free of charging technology for an electric vehicle. The connection level is provided within the housing of the docking station. The connection level is arranged to accommodate the power supply cable. In addition to the cable entry, a possibility of fixing and strain relief can be provided for this purpose. In addition, the connection level accommodates the connection strip for the power supply cable. Furthermore, the connection level is set up to accommodate the energy meter and the power connection for connection to the charging station. The connection level is designed in such a way that the energy meter can be optionally accommodated. An initial configuration of the docking station can provide that the power supply connection is directly connected to the power connection via the connection level. A second configuration of the docking station can provide that the power supply connection is first connected to the energy meter via the connection strip and from there to the power connection.

Inside the housing of the docking station there is a receptacle for the energy meter which is surrounded circumferentially by side walls. Within the side walls of the receptacle there can be cable bushings for power cables from and to the energy meter between the connection strip and the energy meter on the one hand and the energy meter and the power connection on the other hand. The fact that the receptacle is provided means that the energy meter can be sealed off from the inside of the housing if necessary, which is necessary for a tamper-proof measurement of electrical energy, for example. In addition, the side walls of the receptacle may contain cable bushings for a communication cable via which the energy meter can be read out. A protocol for reading the energy meter can be SML and/or TLS.

The receptacle can be closed by a removable lid. Together with the side walls, the lid can have a receptacle for a seal. After the energy meter has been installed in the receptacle and connected electrically, the receptacle for the energy meter can be closed by the lid. Afterwards, a seal can be applied so that subsequent access to the energy meter is no longer possible without destruction.

For installation of the energy meter in the receptacle, the latter may have locking lugs in the area of one edge of the side walls facing away from the bottom in order to accommodate the energy meter in a locking manner. In particular, the energy meter can be mounted inside the docking station without tools, which considerably simplifies its installation.

According to an embodiment, it is proposed that in a protective housing cover detachably arranged on the housing, there is a passaccess which, when connected to the side walls, lies above the power connection arranged in the housing. To close the docking station, the protective housing cover is placed on the docking station. The electrical connections inside the docking station should be protected against external touch so that the protective housing cover has as few access holes as possible. A first access can be located above the power connection. The power connection itself can be protected against contact with its connection contacts, as it is common with connection sockets for power cables.

In addition to the access above the power connection, a further access can be in the area of a communication connection in order to be able to connect the charging station to the wide area network and/or the charging network if necessary. If possible, there are no further accesses, so that the protective housing cover essentially closes the housing, especially in the areas where electrical cables run within the housing between the connection strip, the energy meter and/or the power connection.

Usually the protective housing cover is located at a distance from the power connection, especially its upper edge. In order to prevent manual access through the gap formed between the protective housing cover and the power connection, i.e. between the lower edge of the protective housing cover and the upper edge of the power connection, it is proposed that the protective housing cover has a first circumferential shroud in the area of the access of the protective housing cover, whereby the shroud engages into the interior of the housing in the assembled state. It is also possible for the power connection to have a circumferential shroud which, in the assembled state, extends from the inside of the housing into the access of the protective housing cover. In particular, the shroud has a depth that at least corresponds to the distance between the bottom of the protective housing cover and the top of the power connection. The shroud can also be larger and extend up to the support, in particular the circuit board, on which the power connection is mounted.

When mounting the charging station on the docking station, a power plug of the charging station can be inserted into a power connection formed like a socket. In order to ensure touch protection at the moment of inserting the plug into the socket, the power plug of the charging station is also protected by a surrounding second shroud. According to an advantageous embodiment, this second shroud can engage in an annular gap that is formed circumferentially between the first shroud and the power connection when the protective housing cover is mounted.

For a manual check of the meter reading and/or for the possibility of reading a meter identification, it is proposed that in the housing and/or in the protective housing cover in the area of the receptacle for the energy quantity meter, an opening is provided as a viewing window for a reading area of an energy meter.

The power cable of the power supply connection is usually a rigid cable with only one single strand. Usually, the cable has a cable cross-section of at least 2.5 mm², but preferably beyond that, for example 6 mm², 10 mm², 16 mm² or similar. Such a rigid sheathed cable is difficult to bend and therefore difficult to route. In order to ensure that the installation of the power supply cable at the connection strip is carried out error-free and, in particular, to simplify wiring, it is proposed that a scale be placed on the bottom and/or the side walls of the docking station housing. This scale is used to cut the power supply cable to length as it is passed through the cable entry into the housing. The scale is spaced from the cable entry in such a way that the power supply cable can be cut to size for connection to the terminal strip. This means that the technician can lay the power connection cable against the scale and cut it to length, thus ensuring that the power connection cable can be precisely attached to the connection strip after cutting. Excessive or short lengths of the cut power supply cable are thus avoided, so that incorrect installations are almost impossible.

As already explained at the beginning, the docking station should serve as a connection level and be mechanically connectable with a charging technology that is formed as a supply level. For this purpose, it is proposed that the side walls and/or the protective housing cover have receptacles which interact with the fastening means of a charging station in such a way that the charging station in particular then rests completely on the protective housing cover of the docking station. The installation of the charging station on the docking station is carried out “layer by layer”, in which the charging station lies completely on the docking station as another “layer”. The footprint of the docking station is essentially congruent to the footprint of the charging station. After the docking station has been closed, the charging station can be “docked” to the docking station very easily using the fastening means. In a top view, the charging station then covers the docking station completely or essentially completely, in particular the charging station covers all electrical components within the housing of the docking station.

To prevent access to the fastening means from the outside, it is proposed that the receptacles for fastening means are located between the side walls and the protective housing. Especially at the outer circumferential edge of the protective housing cover, radially inwardly pointing recesses are provided into which the fastening means can be inserted. Thus the fastening means are enclosed within the side walls of the docking station.

The fastening means can preferably be pushed through to the outside of the bottom of the housing of the docking station to be fastened there. For this reason, it is proposed that the bottom of the housing be provided with openings corresponding to the receptacles, with the openings and receptacles aligned with each other. Then, in a linear movement parallel to the longitudinal extension of the fastening means, the fastening means can be inserted through the receptacles into the openings in the bottom of the housing. This makes the installation of the charging station on the docking station particularly easy.

As already explained, the docking station represents the connection level, whereas the charging station represents the supply level. To make installation between the charging station and the docking station particularly easy, the docking station only has connections for a connection to power and preferably also a communication connection. For this reason, only a connection to power and preferably also a communication connection are formed between the docking station and the charging station. The connection to power is formed via the power connection, the communication connection via a network cable, for example.

The charging station encloses the housing walls of the docking station preferably circumferentially. Only in the area of a cable inlet and/or a cable outlet a recess can be provided in the side walls of the charging station surrounding the docking station.

The protective housing cover is preferably recessed from the upper level of the docking station so that the side walls protrude over the protective housing cover in a shroud shape when it is mounted. This makes it possible to ensure a sealing of the docking station by the side walls, for example by providing circumferential sealing strips in the charging station corresponding to the side walls, which are pressed against the edges of the side walls in the mounted state. The cover of the protective housing is recessed to ensure that the sealing strips completely surround the side walls.

Another aspect relates to a charging column with a charging column foot and a charging column head as well as a docking station as described. In this charging station, a receptacle is provided in the charging station head, which is surrounded by circumferential side walls. The docking station can be arranged in this receptacle. The power supply cable can be inserted into the docking station within this receptacle.

After installation of the docking station in the receptacle, an annular gap is formed between the side wall of the docking station and the receptacle and a housing wall of the charging station can engage in this annular gap. If the charging station is coupled with the docking station, it is placed onto the docking station from above. Circumferential side walls of the charging station can engage into the annular gap so that it is not visible from the outside of the charging column that the charging station has been placed onto a docking station.

The head of the charging column can also have a receptacle for one docking station each on two opposite front surfaces.

The charging station comprises a power module (HPS module), a communication module (ECU module) and a user interface module (UI module), whereby the power module has a first charging control circuit for charging control with an electric vehicle. The requirements for charging stations can vary greatly depending on the intended use. Nevertheless, it is desired to create a uniform charging station structure as far as possible, which can be adapted to suit specific needs. In particular, it is first of all necessary that the charging station includes basic charging control functions. Therefore a first charging control circuit is arranged on the power module.

Additional functions, such as extended charging functionalities, billing, communication, user interaction and the like may or may not be necessary. For this reason it is proposed that a communication bus connects the communication module and the user interface module with the power module. Via the communication bus the communication module and/or the user interface module can be coupled if necessary. The function of the power module, in particular the charging control circuit, is initially independent of this, so that the charging station is arranged to provide charging functionalities even without a communication module connected to the communication bus. If the communication module is coupled, further functions such as encryption of billing data, exchange of charging parameters, transmission of information and the like can be provided by the communication module.

If user interaction is desired, it can be provided by the user interface module as soon as it is connected to the communication bus. The communication bus serves to coordinate and synchronize the respective functions on the different modules with each other, so that if necessary the power module on the one hand is always aware of the presence of a communication module and/or a user interface module and on the other hand can also control, trigger and/or detect functions thereof. The same applies to the communication module and the user interface module.

According to an embodiment it is proposed that over the communication bus the communication module and the user interface module are optionally connectable to the power module. As already mentioned, the functions of the first charging control circuit of the power module are independent of it at least in parts. If for example there is a second charging control circuit on the communication module, then this can override the first charging control circuit at least in parts, can however also take over and supplement functions of the first charging control circuit.

According to an embodiment, it is proposed that the communication module and the user interface module can be connected to the power module via the communication bus in a plug and play manner. Here the connected modules can log themselves in or out of the power module over the bus. In addition to the communication functionality, the communication bus also provides for example a power supply for the communication module and/or the user interface module. A multi-voltage supply is also possible, for example 3.3 V, 5 V and/or 12 V. Both communication and power supply can be provided via a single multicore cable, for example a flat cable. An RS422 bus is particularly suitable as a communication bus between the respective modules. The power module, the communication module and the user interface module are each located on a separate circuit board. This also provides mechanical decoupling of the functions of the respective modules, so that they can be arranged in the charging station as required.

As already mentioned, the charging station with the power module is intended to provide basic functionalities for charging an electric vehicle. It is therefore proposed that the first charging control circuit is arranged to be independent of the communication module and/or the user interface module for charging control with an electric vehicle.

For this purpose, it is proposed that the charging control circuit is arranged for charging control by pulse width modulation. In particular, the communication with the electric vehicle should happen exclusively via an energy conductor. The first charging control circuit is in particular set up for charging control according to DIN 61851.

In addition to the charging control circuit on the power module, the communication module can have a second, independent charging control circuit for charging control with an electric vehicle.

It is proposed that the second charging control circuit has an extended range of functions compared to the first charging control circuit. This extended range of functions refers in particular to the possibility of negotiating charging parameters with the electric vehicle. It is proposed that the second charging control circuit is set up for charging control via a pilot wire with the electric vehicle. The second charging control circuit supports in particular a communication protocol according to DIN 15118 or Chademo.

A charging outlet is arranged at the power module. In addition to the connections for phase and neutral conductor, this charging outlet also has a connection for an earth conductor and a connection for a PP (Plug Present) contact as well as a CP (Pilot Conductor) contact.

Especially the PP and CP contact of the charging outlet are connected to the second charging control circuit via the communication bus. This enables the second charging control circuit to communicate with the electric vehicle at least via the CP and PP contacts.

The second charging control circuit may have functions that are complementary to the functions of the first charging control circuit. In this case it is proposed that the second charging control circuit overrides the charging control of the first charging control circuit at least in parts.

The power module serves in particular for power monitoring and power protection. For power protection, a circuit breaker, a fuse, a residual current circuit breaker, a ground fault circuit interrupter (GFCI) sensor, a welding detection sensor and/or a control for an electrical connector release are installed on the power module. The monitoring can be carried out phase by phase or for all phases simultaneously, whereby phase by phase monitoring is always preferred.

The communication module can have components for wireless communication in a local network and/or a wide area network. In particular, radio protocols such as LTE, UMTS, GSM, 5G, WLAN, for example according to IEE E802.11, Bluetooth, RFID, NFC or other protocols for wired and/or wireless communication are integrated on the communication module.

The communication module can moreover contain an encryption circuit, which can be formed as a TPM (Trusted Platform Module) for example. This can be used, for example, to establish a communication with a smart meter, iMS in the docking station using SML or TLS and to establish secure communication with a billing center.

With the help of the communication module, the charging station can be optionally equipped as master or slave. For this purpose, a master controller or a slave controller can be optionally arranged on the communication module. In case of a master configuration, the communication module can be equipped with the extended communication functionalities for wireless communication. A charging station with a communication module set up as a master can control further charging stations that only have a communication module with a slave controller. In this way, via a local network, which is controlled e.g. by the communication module, a plurality of charging stations can be equipped with extended communication functionalities, whereby only one of the charging stations acts as master and all other charging stations act as slaves.

A display interface and/or a touch display interface can also be arranged on the communication module. Via one of these interfaces a display or a touch display, which is arranged on the user interface module, can be controlled. Via one of these interfaces a display or a touch display, which is spatially separated from the user interface module, e.g. in a separate housing from the charging station, can be controlled. This makes it possible to use the charging station as a control center for information and/or advertising displays, for example. The communication and control capability is arranged on the communication module and the displays themselves no longer require such functionality.

According to an embodiment, it is proposed that a communication module equipped with a master controller can receive measured values via an interface, for example via a LAN interface, from a communication module equipped with a slave controller. These measured values can be collected by the measuring device on the charging station equipped with the slave controller and be transmitted to the charging station with the master controller. The communication module with the master controller can encrypt the received measured values for further billing. The encrypted measured values can be transmitted from the encryption circuit to a billing center.

On the user interface module, various sensors can be arranged on at least one side of the circuit board. The sensors are arranged in particular on the side of the circuit board which faces a lid surface in the assembled state. Sensors can be for example radar sensors, capacitive or inductive proximity sensors or the like. Also, a radio antenna, especially a near field antenna, can be arranged on the user interface module, for example to support RFID functions and/or NFC functions. The antenna can be formed as a PCB-antenna.

In addition, a display interface for at least one display and/or a touch display interface for at least one touch display can be arranged on the user interface module.

A display, a touch display and/or a brightness sensor can also be arranged on the user interface module.

The touch display is preferably controlled via a touch display interface on the communication module. A display is preferably controlled via a display interface on the communication module. The (touch) display is controlled by the communication module. The user interface module preferably only accommodates the (touch) display itself and arranges it correctly on the lid relative to the lid surface.

According to an embodiment, it is proposed that the power module is located in a tray assembly and that the communication module and/or the user interface module are located in a lid assembly.

### BRIEF DESCRIPTION OF THE DRAWING

Below, the subject matter is explained in more detail with the help of a drawing showing examples of embodiments. In the drawing show:

FIG. 1 is a schematic view of a charging station;

FIG. 2 is an exploded view of a charging station with docking station and charging station;

FIG. 3 is a view of an open docking station;

FIG. 4 is a view of a closed docking station;

FIG. 5 is an exploded view of a tray assembly;

FIG. 6 is a tray assembly in a partially assembled state;

FIG. 7 is a bottom view of a tray assembly;

FIG. 8a-c are assembled tray assemblies without covers;

FIG. 9 is a view of a lid assembly;

FIG. 10 is a bottom view of a lid assembly; and

FIG. 11 is a sectional view of a lid assembly.

### DETAILED DESCRIPTION

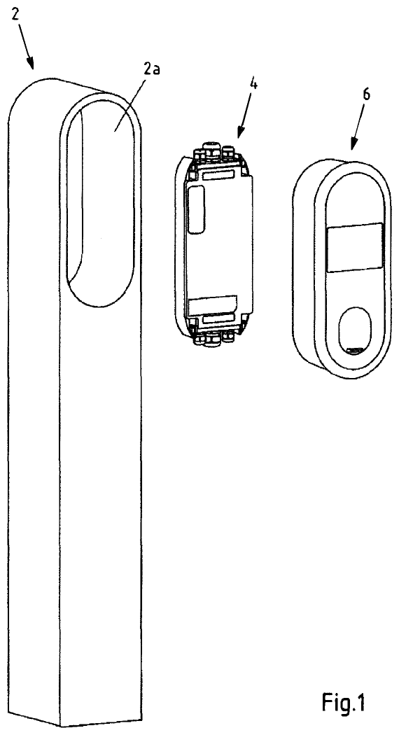

FIG. 1 shows a charging station with a charging column 2, in which a receptacle 2a is provided. The receptacle 2a of the charging column 2 is designed to accommodate a docking station 4 and a charging station 6. The docking station 4 can be fixed in the receptacle 2a in a manner not described in detail. An electrical connection to a power supply system can be routed into the docking station 4 via the charging column 2. The charging station 6 can be assembled as an assembly with a tray assembly and a lid assembly, which are described in more detail below, and can be placed on the docking station 4 and mechanically fixed to the docking station 4.

Together with the mechanical fixation, the charging station can be electrically coupled to the docking station 4 via a plug/socket. A communication link can be established via at least one patch cable between the docking station 4 and the charging station 6.

When installed, the docking station 4 is completely accommodated in the receptacle 2a and the charging station 6 essentially completely embraces the outer edge of the docking station 4 and is also at least partially recessed in the receptacle 2 with its side edges.

If required, however, the docking station 4 can also be mounted directly on a wall without the need for the charging station 2 with the receptacle 2a. In this case, too, the side walls of the docking station are at least partially embraced by side walls of charging station 6.

As can be seen in FIG. 1, the footprints of docking station 4 and charging station 6 are approximately congruent to each other, so that when assembled, charging station 6 completely covers docking station 4 when viewed from the front.

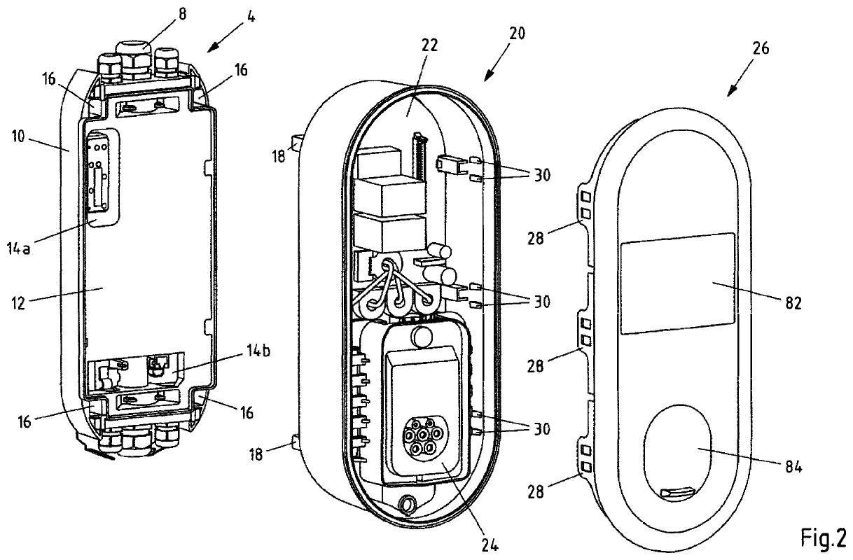

The modular design of docking station 4 and charging station 6 is shown in FIG. 2.

FIG. 2 shows the docking station 4, which has a cable entry 8 in a side wall 10. The docking station 4 is at least partially closed by a protective housing cover 12 on the side facing the charging station 6. The cover 12 is provided with recesses 14a, 14b, which are described in more detail below.

The charging station 6 may comprise a tray assembly 20 and a lid assembly 26.

Openings 16 can be provided between the cover 12 and the side wall 10. Through these openings 16, webs 18 of the tray assembly 20 can be inserted into the docking station 4, so that the tray assembly 20 can be fixed to the docking station 4 via the webs 18.

As already explained, the tray assembly 20 can be coupled to the docking station 4. The tray assembly 20 is part of the charging station 6, which additionally comprises the lid assembly 26. The tray assembly 20 accommodates a power module 22 and a charging socket 24. The tray assembly 20 is essentially closed with a bottom on the bottom side and is closed on the lid side by the lid assembly 26.

Lid assembly 26 can be fixed to locking means 30 in the side walls of tray assembly 20 using locking means 28. The lid assembly 26 can comprise a shutter 32 and control elements, such as a display 34.

In the assembled state, the lid assembly 26 is mechanically joined to the tray assembly 20 and thus closes the tray assembly 20 at a top side. At the bottom side, the tray assembly 20 is joined to the docking station 4 and the side walls 10 provide a seal between the docking station 4 and the tray assembly 20.

A sealing is formed between the lid assembly 26 and the tray assembly 20 along the outer edge facing the lid assembly 26. The docking station 4 serves as a connection level and can be connected to a power supply network independently of the charging station 6. As long as the charging station 6 is not coupled to the docking station 4, it is voltage-free. The charging station 6 is connected to the energy supply network by coupling of the charging station 6 with the docking station 4. The charging station 6 can be understood as a supply level, which has charging technology and other “intelligence”. This modular design makes it possible to first assemble the docking station 4 by a qualified fitter without the need to immediately install a charging station 6.

At any later point in time, the charging station 6 can be particularly easily coupled to the docking station 4 also by a technical layman, mechanically and without tools, whereby the charging station 6 is then automatically electrified. As explained above, the charging station 6 is particularly flexible and modular due to its special design comprising a tray assembly 20 and lid assembly 26 and can be adjusted to the respective application.

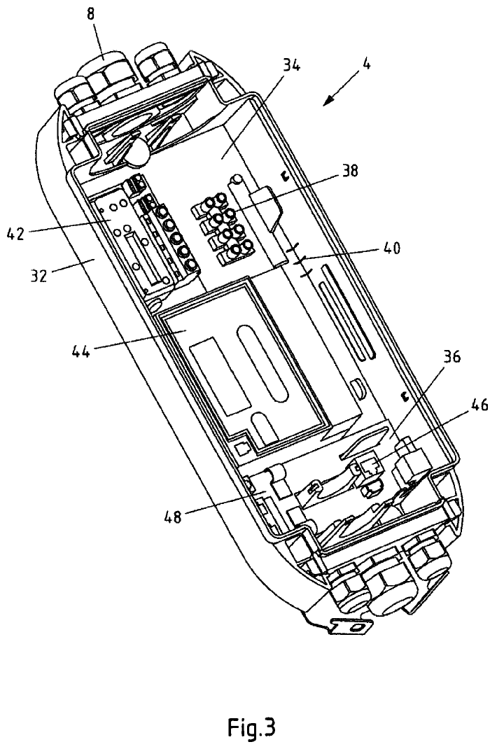

The docking station 4 is shown in detail in FIG. 3. The docking station 4 has a bottom and side walls 32. A main board 34 and an interface board 36 are located on the bottom of the docking station 4. On the main board 34 there is a connection strip 38 for connecting a power supply cable.

On the side walls 32 and/or the bottom, scale lines 40 can be provided.

In addition to the connection strip 38, a power connector 42 is provided as a socket on the main board 34.

Furthermore, a receptacle 44 is provided between the side walls 32. The receptacle 44 can be closed by a cover. A measuring device, e.g. a smart meter or an iMS can be anchored in a latched manner into the receptacle 44. Not shown are cable bushings through the side walls of the receptacle 44 to wire the measuring device. The receptacle 44 can be sealed via suitable drill holes which is not shown in detail.

On the interface board 36, connectors 46, 48 are provided for a network cable and for a CAN bus and/or a GPIO bus. In addition, there may also be connection sockets for a connection to the modules inside the charging station.

The external wiring to a local network is done via a connection strip, which is then accessible via an RJ45 socket. In particular, sufficient contacts are provided here to connect to at least two independent local networks. For example, a first local network can be formed with a central unit and a second local network between master and slave units, i.e. between a charging station with a master controller with at least one, preferably several charging stations with only one slave controller. The two local networks can be connected together via a single patch cable to charging station 6 or the modules arranged in it.

To install the docking station 4, it is first mechanically fixed either in the receptacle 2 or, for example, screwed to a wall. Then, a multicore power cable is inserted through the cable entry 8 into the interior of the docking station 4. This cable has in particular large cable cross sections and a rigid cable core. Therefore, the cables are difficult to handle. To ensure that the cables are always cut to the correct length, the technician can place the cable against the scale 40 and cut it to length immediately. This enables the technician to correctly adjust the connection cable so that he can subsequently lay it on the connection strip 38 without any problems.

Depending on the assembly, a measuring device can be arranged in the receptacle 44. This measuring device is wired via flexible cables originating from the connection strip 38. Originating from the measuring device again a wiring via flexible cables towards a power connection 42 is done. If no measuring device is installed, the wiring is done directly via a flexible cable between the connection strip 38 and the power connection 42. A connection strip is also provided at the power connection 42 to accommodate the respective cables.

A network cable can also be inserted into the housing of the docking station 4 via the cable entry 8 and be connected to the connections 48.

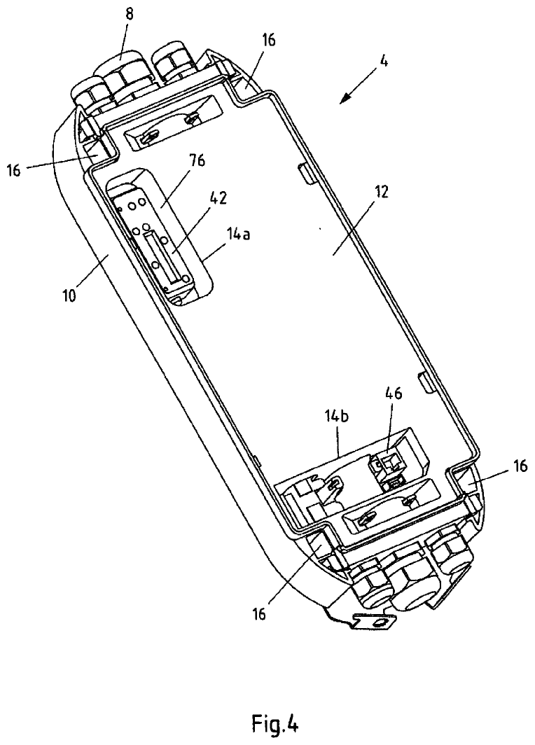

After the electrical wiring has been carried out, the housing of the docking station 4 is closed with a cover 12 as shown in FIG. 4.

In FIG. 4 it can be seen that in addition to the recess 14a for the power connection 42, the cover 12 has at least one further recess 14b for the communication connections of the interface board 36, in particular an RJ45 connector as well as a GPIO connector and a CAN bus connector. Via the RJ45 socket 46, an RJ45 plug can establish a connection with two separate LAN networks.

Openings 16 are provided at the side edges of the protective housing cover 12. The openings 16 are located between the cover 12 and the side wall 10 of the docking station 4. Through the openings 16, the webs 18 of the tray assembly 20 can be inserted into the docking station 4, so that these webs 18 are completely accommodated by the side wall 10 of the docking station 4. Thus, the charging station 6 is mechanically anchored within the docking station 4 by the tray assembly 20.

After the docking station 4 has been installed in the manner shown, it can first remain unequipped, protected by the protective housing cover 12, and can be equipped at any later time with a charging station 6 comprising tray assembly 20 and lid assembly 26.

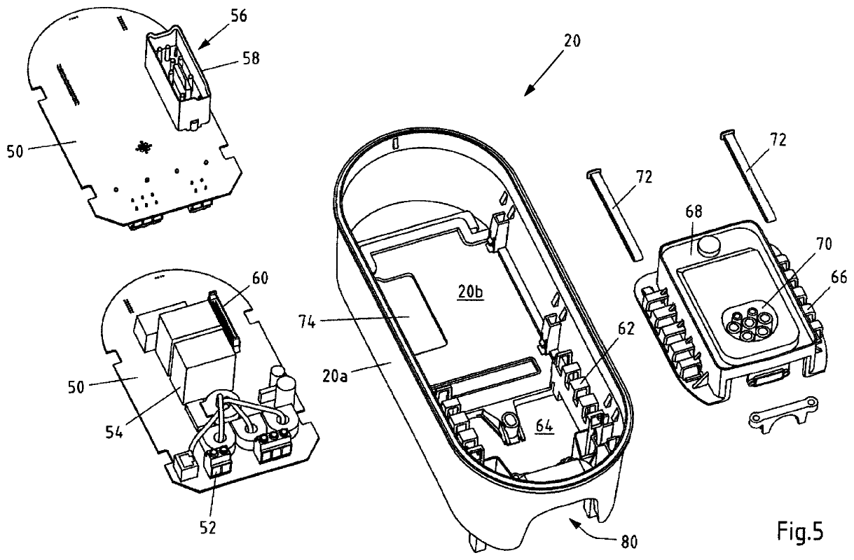

A tray assembly 20 is shown in FIG. 5 in a configuration variant. The tray assembly 20 has a housing with side walls 20a and a bottom 20b. In the area of the side walls 20a and the bottom 20b, a power module 50 can be mechanically anchored to the bottom of the tray assembly 20. The power module 50 has a charging connection 52 and a charging control circuit 54. On the bottom side of the power module, as also shown in FIG. 5, there is a plug 56 which corresponds to the socket of the power connection 42. The plug 56 is surrounded by a shroud 58. The shroud 58 points away from the surface of the circuit board of the power module 50. In particular, the shroud 58 has an extension in this direction which is greater than the longest extension of any contact of plug 56.

Additional components for power monitoring and/or power control are provided on the power module 50. In addition, a connector 60 for a communication bus is arranged on the power module 50.

Connector 60 for the communication bus enables the communication bus to be connected to the power module 50. The communication bus can take up both a communication module and a user interface module, which are described in the following, in the kind of plug and play and connect it with the power module 50. This makes it possible to supplement the power module 50 with the help of the communication module and/or the user interface module in a modular way in order to be able to adapt charging station 6 to the respective requirements if necessary.

The power module 50 is located in a first area of the bottom 20b. In a second area of the bottom 20b, a fixing means 62 is provided, which is formed by flanges arranged in a comb-like manner with openings aligned to each other. The fixing means 62 is formed by two comb-like structures facing each other and enclosing an opening 64 in the base 20b. The fixing means 62 correspond to fixing means 66 of a receptacle 68 for a charging socket 70. The charging socket 70 is located directly above the opening 64 in the assembled state. Through the opening 64, it is possible to perform a manual emergency release at the charging socket 70 from the bottom of the tray assembly 20 through the base 20b.

To mount the fixing body 68 to the tray assembly 20, the mounting body 68 with its fixing means 66 is aligned with the fixing means 62 in such a way that pins 72 can be pushed through the aligned openings. Thereby the pins 72 fix the mounting body 68 to the housing of the tray assembly 20.

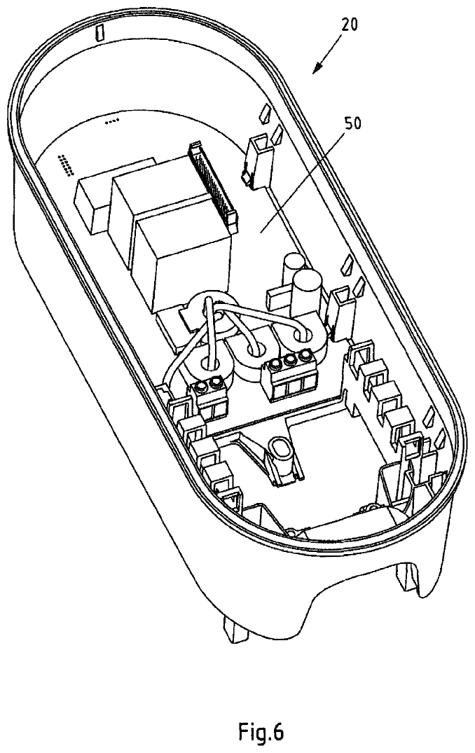

In a partially assembled state, the power module 50 is inserted into the bottom of the tray assembly 20, as shown in FIG. 6. Here, the plug 56 is pushed through the opening 74 at the bottom together with the shroud 58. The power module 50 is mechanically interlocked with the housing of the tray assembly 20 and can be supported floatingly. Alternatively or commutatively, it is possible that the main board 34 is supported floatingly in the housing of the docking station 4. The floating support has the advantage that when the tray assembly 20 is mounted on the docking station 4, the plug 56 can autonomously align itself with the socket of the power connection 42. This increases the operability, in particular it facilitates the assembly by a layman.

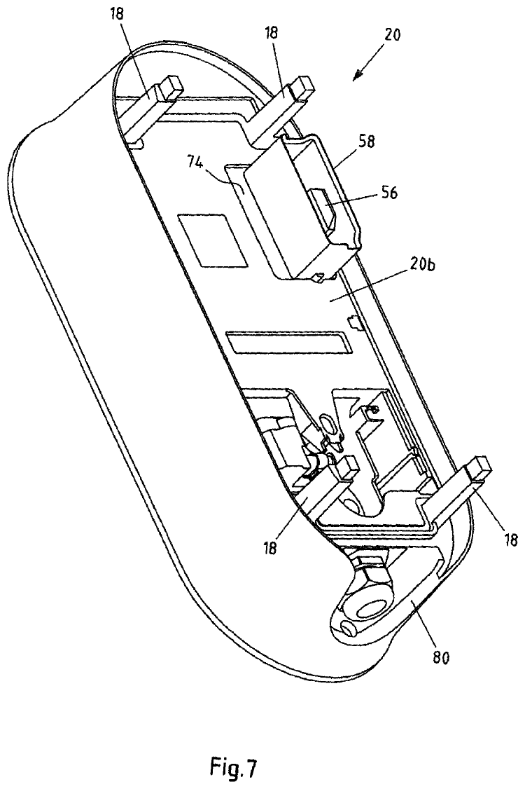

The bottom side of the tray assembly 20 is shown in FIG. 7. It can be seen that the webs 18 protrude from the bottom 20b pointing away from the tray assembly 20. Furthermore, the shroud 58 with the plug 56 can be seen protruding through the opening 74.

When assembled, the shroud 58 engages with the opening 14a. As can be seen in FIG. 4, an annular gap 74 is formed in the opening 14a between the socket of the power connection 42 and a shroud 78 projecting into the interior of the housing of the docking station 4. The shroud 78 provides touch protection for the docking station 4.

During assembly, the tray assembly 20 is placed on the docking station 4 and, as can be seen from the combination of FIGS. 4 and 7, the shroud 58 slides into the annular gap 76. The shroud 58 enters the annular gap 76 before a contact of the plug 56 comes into electrical contact with a contact of the socket of the power connection 42. This prevents that an electric shock can occur when mounting the tray assembly 20 on the docking station 4.

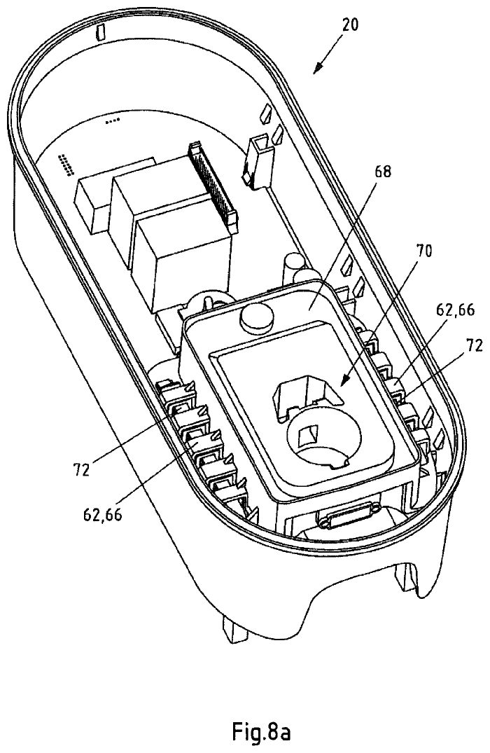

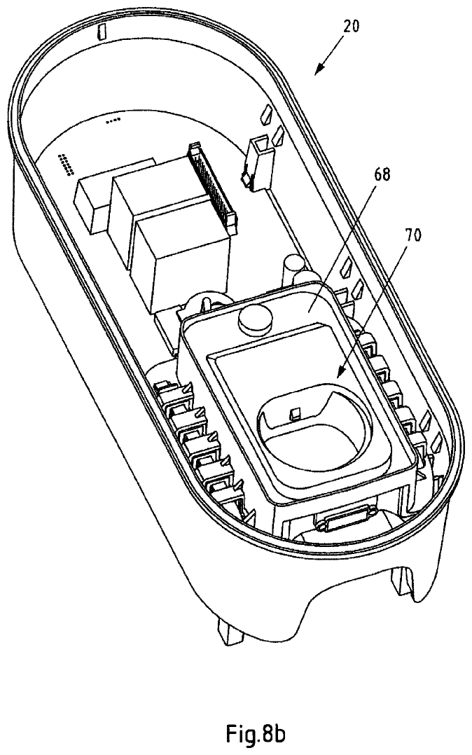

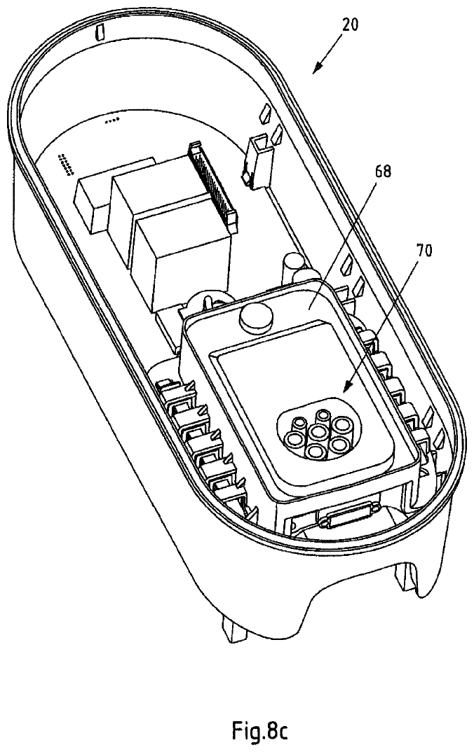

The receptacle body 68 is designed in such a way that it is equipped to accommodate a wide variety of charging sockets 70, or in other words, a wide variety of charging sockets 70 can be equipped with different receptacle bodies 68, whereby the fixing means 66 have the same distance from each other and thus form a uniform mechanical interface to the fixing means 62. This leads to the possibility of installing different charging sockets 70 in the same tray assembly 20, as shown in FIG. 8a-c.

There, it can be seen that the fusing elements 62, 64 engage with each other and are mechanically latched together via pins 72. FIG. 8a shows a receptacle body 68 with a CCS charging socket 70, FIG. 8b shows a receptacle body 68 with a Chademo charging socket 70 and FIG. 8c shows a receptacle body 68 with a type 2 charging socket 70.

As can be seen in FIG. 8a-c, the receptacle body 68 makes it possible to accommodate a variety of charging sockets 70 without having to make any design changes to the housing of the tray assembly 20.

The charging sockets 70 do not necessarily need to be electrically connected to the charging connection 52, but can also remain potential-free. In this case, the charging sockets 70 can serve as a “plug garage”. The charging outlet 52 can be electrically connected to a charging cable permanently attached to the housing of the tray assembly 20. The charging cable can be led out in the area of a recess 80 in the side wall of the tray assembly 20.

If no permanently attached cable is used, the charging socket 70 can be electrically connected to the charging control circuit 54 via the charging connector 52. The charging connection 52 has three connections for one phase each on a connection strip, another connection strip with two connections for the neutral conductor and the protective conductor and, if necessary, a connection socket for a plug present (PP) contact and a pilot conductor (CP) contact.

For the installation of the charging socket 70, the receptacle body 68 is arranged on the tray assembly 20, the charging socket 70 is connected to the respective connections of the charging outlet 52 via pre-assembled cables and then the receptacle body 68 is fixed in the tray assembly 20 via the pins 72.

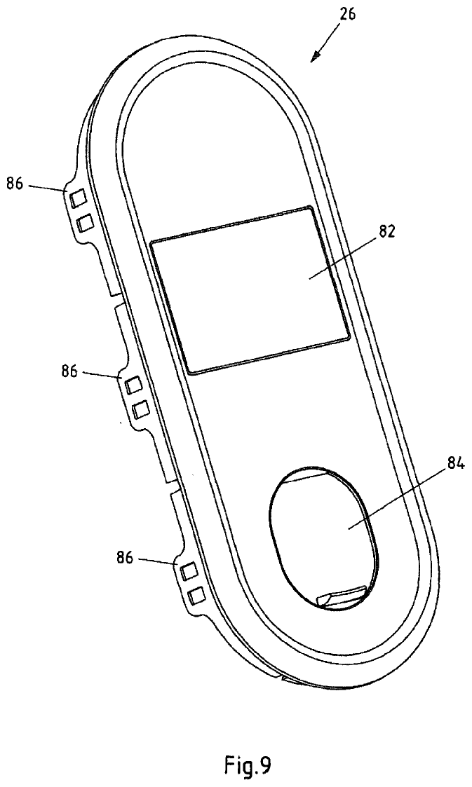

In addition to the tray assembly 20, the charging station 6 also includes the lid assembly 26 as shown in FIG. 9. The top side of lid assembly 26 can have various control elements 82 and/or a shutter 84 on a top side. The lid assembly 26 may have latching elements 86 on its side edges, which can engage with the inner side walls of the tray assembly 20. This allows the lid assembly 26 to be mounted on the pan assembly 20.

The latching elements 86 may be designed to snap into the side walls of the tray assembly 20 and, in particular, may only be released non-destructively when released from the bottom, coming from the bottom 20b of the tray assembly 20. This prevents the lid assembly 26 from being detached from the tray assembly 20 while the pan assembly 20 is still electrically connected to the main board 34 of docking station 4.

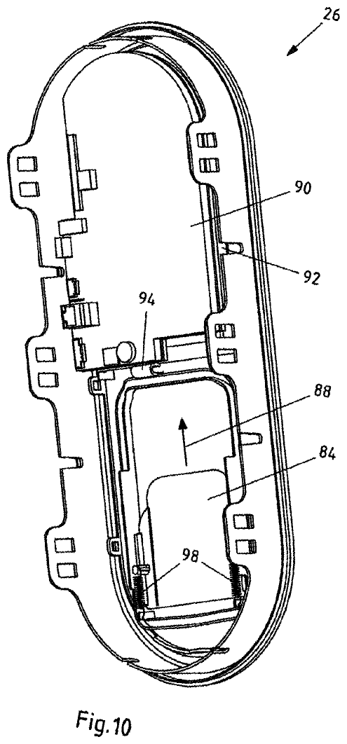

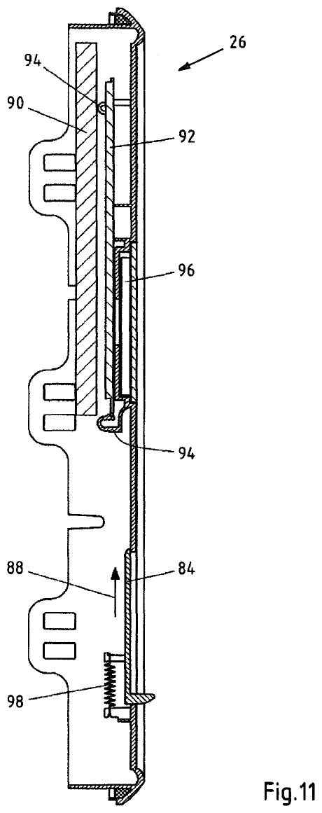

At the rear of lid assembly 26, as shown in FIG. 10, the shutter 84 is mounted in a way that it can be moved in a movement direction 88 to make the charging socket 70 accessible. As shown in FIG. 11, the shutter 84 is spring-loaded via a spring 98 so that it automatically moves into the shown closed position.

A communication module 90 and a user interface module 92 can be arranged in another area of the lid assembly 26. Both the communication module 90 and the user interface module 92 can be mechanically fixed to the lid assembly 26 or its housing.

The communication module 90 is connected to the power module 50 and the user interface module 92 via the communication bus.

The communication module 90 includes a charging control circuit not shown in detail, which has electrical access to the charging connection 52. The charging control circuit can override the charging control circuit 54 or at least be coupled to it, so that the two charging control circuits can control the charging process in a coordinated manner.

FIG. 11 shows the arrangement of the communication module 90 as well as the user interface module 92 in the lid assembly 26. The user interface module 92 faces the inside of the lid surface and is mechanically connected to the housing of the lid assembly 26 via click connections 94. The communication module 90, in turn, is also connected to the housing of lid assembly 26 via connections not shown in detail.

The user interface module 92 is fixed immovably to the inside of the lid assembly 26, so that an exact positioning of sensors and signal transmitters on the user interface module 92 in relation to the top of the lid assembly 26 is guaranteed. In particular, a display 96 can be optionally located in the lid assembly 26 and controlled via the user interface module 92 and/or the communication module 90.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A charging station for electric vehicles comprising:
a tray assembly and
a lid assembly,
wherein the tray assembly comprises at least one power module, a first charging control circuit, and at least one charging outlet; and
wherein the lid assembly is arranged to accommodate at least one communication module and at least one user interface module.

2. The charging station according to claim 1, wherein the tray assembly has a tray-shaped housing and side walls of the housing embrace the power module circumferentially.

3. The charging station according to claim 1, wherein the tray assembly has a bottom.

4. The charging station according to claim 3, wherein the power module is formed as a circuit board which is mounted floatingly in a plane substantially parallel to the bottom.

5. The charging station according to claim 3, wherein the power module has a power connection, wherein the power connection is arranged in a recess in the bottom.

6. The charging station according to claim 5, wherein the power connection is enclosed by a circumferential shroud, wherein the power connection is embraced by the circumferential shroud and the circumferential shroud extends through the bottom facing away from the interior of the tray assembly

7. The charging station according to claim 3, wherein the bottom has a recess for receiving a charging socket.

8. The charging station according to claim 1, wherein the tray assembly comprises a receptacle for a charging socket, wherein the receptacle comprises fixing means for detachably fixing the charging socket to the tray assembly, in particular wherein the fixing means are arranged to receive different charging sockets, in particular a type 1, type 2, type 3 or CCS charging socket according to IEC 62196 or a Chademo charging socket.

9. The charging station according to claim 8, wherein the fixing means are formed by comb-shaped flanges with openings aligned with each another, so that comb-shaped flanges arranged on the charging socket can engage in the flanges of the fixing means and can be fixed thereto by a pin guided through the openings.

10. The charging station according to claim 1, wherein bottom-side webs extend away from the interior of the tray assembly, wherein the webs are arranged to engage in recesses at a docking station, and in particular wherein the webs can be fixed positively to the docking station.

11. The charging station according to claim 1, wherein the power module comprises at least one circuit breaker.

12. The charging station according to claim 1, wherein the power module comprises the first charging control circuit, the charging outlet, and the circuit breaker on a circuit board.

13. The charging station according to claim 12, wherein the first charging control circuit on the power module is arranged for communication with an electric vehicle on an energy conductor, in particular by means of pulse width modulation, in particular wherein the first charging control circuit supports communication in accordance with DIN61851.

14. The charging station according to claim 1, wherein the charging outlet is connected to a charging cable arranged on the tray assembly and led out of the tray assembly or that the charging outlet is connected to a charging socket.

15. The charging station according to claim 1, wherein the lid assembly accommodates the communication module and the user interface module in such a way that, coming from the lid surface, first the user interface module and then the communication module are arranged.

16. The charging station according to claim 1, wherein the communication module and the user interface module are each formed on a separate circuit board.

17. The charging station according to claim 1, wherein the lid assembly corresponds to the tray assembly over its entire surface area and in particular can be connected to the tray assembly by means of latching elements which latch on the inside of the side walls of the tray assembly.

18. The charging station according to claim 1, wherein the communication module and the user interface module are arranged in a first area of the lid surface and wherein a shutter is arranged on the lid surface in a second area corresponding to the charging socket in the tray assembly.

19. The charging station according to claim 1, wherein the user interface module is fixed to the inside of the lid surface so that signal generators and/or signal sensors on the user interface module are immovable relative to control elements located on the outside of the lid surface.

20. The charging station according to claim 1, wherein the communication module and/or the user interface module are mechanically connected to the power module exclusively indirectly via a connection between the lid assembly and the tray assembly.

21. The charging module according to claim 1, wherein the communication module and/or the user interface module are electrically connected to the power module by a flexible cable.

22. The charging station according to claim 1, wherein the communication module comprises a second charging control circuit for communication with an electric vehicle via a pilot conductor at the charging outlet.

23. The charging station according to claim 1, wherein the communication module comprises an encryption circuit, wherein the encryption circuit receives a measured value from a smart meter arranged in a docking station and transmits the measured value in an encrypted form to a billing center.
